(19) United States
(12) Patent Application Publication
(10) Pub. No.: US 2022/0313559 A1
(43) Pub. Date: Oct. 6, 2022

(54) FOOD HOLDING DEVICE WITH TETHERED COVER AND SUPPORT

(71) Applicant: Sandy Bastien, Monroe, NY (US)

(72) Inventor: Sandy Bastien, Monroe, NY (US)

(73) Assignee: Baba Lid Products, Monroe, NY (US)

(21) Appl. No.: 17/838,164

(22) Filed: Jun. 11, 2022

Related U.S. Application Data
(63) Continuation-in-part of application No. 29/739,593, filed on Jun. 26, 2020.

(51) Int. Cl. A61J 9/08; A61J 11/04; A61J 11/00

(52) U.S. Cl. CPC A61J 9/08; A61J 11/04; A61J 11/008

(57) ABSTRACT

A food-containing device includes a container having a body with a foot and a neck. An exemplary neck defines an opening in the body and the foot is adjacent to the bottom of the body. An exemplary a cover for the device is configured to close the opening in the neck when interconnected to the container body but can also couple to the foot of the body. Each of the cover and container are interconnected by a flexible link.

### RELATED APPLICATION DATA

This application is a continuation-in-part of and claims the benefit of priority of U.S. Design patent application Ser. No. 29/739,593, filed Jun. 26, 2020, the entire disclosures of which are incorporated herein by reference in their entirety.

### FIELD OF THE INVENTION

Disclosed are embodiments of the invention that relate to, among other things, a device for holding edible substances (foods or drinks).

### BACKGROUND

Almost all portable food containers comprise a container for the food (whether it is liquid or solid in form) and a cover for the container that holds the food. However, these covers for portable food containers are separated from their containers and require the user to always know where they are after opening the container.

In the context of feeding infants, babies, and small children, portable food containers are typically accessed quickly to feed the infant, baby, or small child, with the consequent quick removal and displacement of the cover for said container. Thus, users of such containers will misplace, drop, or forget the covers in the midst of feeding the infant, baby, or small child. However, the covers for these types of containers, such as baby bottles, are particularly necessary to prevent unwanted debris from coming in contact with the opening of the container, e.g., a baby bottle nipple, or sippy cup nozzle. Therefore, there is a need to maintain the covers of such food containers in close proximity to the user to avoid one or more of the foregoing issues from occurring.

There is also a need to keep the cover of food containers within reach during use. In addition to the aforementioned example involving feeding young infants, babies, and/or small children, those in outdoor situations, traveling, hiking, or long trips may find that the food container may need to be revisited more than one time. Each time the food container is used and its use completed, the user may want to maintain the cover nearby to conveniently seal the food container. This issue has yet to be satisfied in the prior art.

### SUMMARY OF THE INVENTION

An exemplary food-containing device may be made up of a substantially rigid container having a body with a foot and a neck. In an exemplary body, the neck may define an opening in the body and the foot is adjacent to a bottom of the body. An exemplary food-containing device may also have a cover with an upper surface and a lower surface. An exemplary upper surface may be configured to block the opening in the neck when interconnected to the neck. An exemplary lower surface may be configured to couple the cover to the foot of the body so that the upper surface may be in a plane substantially parallel to the bottom of the body. The exemplary food-containing device may have a flexible link for interconnecting the cover to the container.

Another exemplary food-containing device may be made up of a substantially rigid container having a body with a foot and a neck. In an exemplary body, the neck may define an opening in the body and the foot is adjacent to a bottom of the body. An exemplary food-containing device may also have a cover with an upper surface and a lower surface. An exemplary upper surface may be configured to block the opening in the neck when interconnected to the neck and may be interconnected to the neck via a ring structure coupled to the neck. An exemplary lower surface may be configured to couple the cover to the foot of the body so that the upper surface may be in a plane substantially parallel to the bottom of the body. The exemplary food-containing device may have a flexible link for interconnecting the cover to the container.

Another exemplary food-containing device may be made up of a substantially rigid container having a body with a foot and a neck. In an exemplary body, the neck may define an opening in the body and the foot is adjacent to a bottom of the body. An exemplary food-containing device may also have a cover with an upper surface and a lower surface. An exemplary upper surface may be configured to block the opening in the neck when interconnected to the neck and may be interconnected to the neck via a ring structure coupled to the neck. An exemplary lower surface may be configured to couple the cover to the foot of the body so that the upper surface may be in a plane substantially parallel to the bottom of the body. The exemplary food-containing device may have a flexible link for interconnecting the cover to the container and a dispenser coupled to the container via the ring structure.

Another exemplary food-containing device may be made up of a substantially rigid container having a body with a foot and a neck. In an exemplary body, the neck may define an opening in the body and the foot is adjacent to a bottom of the body. An exemplary food-containing device may also have a cover with an upper surface and a lower surface. An exemplary upper surface may be configured to block the opening in the neck when interconnected to the neck and may be interconnected to the neck via a ring structure coupled to the neck. An exemplary lower surface may be configured to couple the cover to the foot of the body so that the upper surface may be in a plane substantially parallel to the bottom of the body. The exemplary food-containing device may have a flexible link for interconnecting the cover to the container and a dispenser coupled to the container via the ring structure. One type of exemplary dispenser is a nipple.

Another exemplary food-containing device may be made up of a substantially rigid container having a body with a foot and a neck, whereby each of these is safe for use with infants. In an exemplary body, the neck may define an opening in the body and the foot is adjacent to a bottom of the body. An exemplary food-containing device may also have a cover with an upper surface and a lower surface. An exemplary upper surface may be configured to block the opening in the neck when interconnected to the neck and may be interconnected to the neck via a ring structure coupled to the neck. An exemplary lower surface may be configured to couple the cover to the foot of the body so that the upper surface may be in a plane substantially parallel to the bottom of the body. The exemplary food-containing device may have a flexible link for interconnecting the cover to the container and a dispenser coupled to the container via the ring structure. One type of exemplary dispenser is a nipple.

Another exemplary food-containing device may be made up of a substantially rigid container having a body with a foot and a neck. In an exemplary body, the neck may define an opening in the body and the foot is adjacent to a bottom of the body. An exemplary food-containing device may also have a cover with an upper surface and a lower surface. An exemplary upper surface may be configured to block the opening in the neck when interconnected to the neck via one or more surfaces on the neck and may be interconnected to the neck via a ring structure coupled to the neck. An exemplary lower surface may be configured to couple the cover to the foot of the body so that the upper surface may be in a plane substantially parallel to the bottom of the body. The exemplary food-containing device may have a flexible link for interconnecting the cover to the container.

Another exemplary food-containing device may be made up of a substantially rigid container having a body with a foot and a neck. In an exemplary body, the neck may define an opening in the body and the foot is adjacent to a bottom of the body. An exemplary food-containing device may also have a cover with an upper surface and a lower surface. An exemplary upper surface may be configured to block the opening in the neck when interconnected to the neck via one or more surfaces on the neck and may be interconnected to the neck via a ring structure coupled to the neck. An exemplary lower surface may be configured to couple the cover to the foot of the body so that the upper surface may be in a plane substantially parallel to the bottom of the body. The exemplary food-containing device may have a flexible link for interconnecting the cover to the container via a passage in the cover and a passage in the container.

Another exemplary food-containing device may be made up of a substantially rigid container having a body with a foot and a neck. In an exemplary body, the neck may define an opening in the body and the foot is adjacent to a bottom of the body. An exemplary food-containing device may also have a cover with an upper surface and a lower surface. An exemplary upper surface may be configured to block the opening in the neck when interconnected to the neck via one or more surfaces on the neck and may be interconnected to the neck via a ring structure coupled to the neck. An exemplary lower surface may be configured to couple the cover to the foot of the body so that the upper surface may be in a plane substantially parallel to the bottom of the body. The exemplary food-containing device may have a flexible link for interconnecting the cover to the container via a passage in the cover and a passage in the container. The exemplary food-containing device may further have a dispenser coupled to the container via the ring structure. One type of exemplary dispenser is a nipple.

Another exemplary food-containing device may be made up of a substantially rigid container having a body with a foot and a neck. An exemplary container is safe for use with infants. In an exemplary body, the neck may define an opening in the body and the foot is adjacent to a bottom of the body. An exemplary food-containing device may also have a cover with an upper surface and a lower surface. An exemplary upper surface may be configured to block the opening in the neck when interconnected to the neck via one or more surfaces on the neck and may be interconnected to the neck via a ring structure coupled to the neck. An exemplary lower surface may be configured to couple the cover to the foot of the body so that the upper surface may be in a plane substantially parallel to the bottom of the body. The exemplary food-containing device may have a flexible link for interconnecting the cover to the container via a passage in the cover and a passage in the container. The exemplary food-containing device may further have a dispenser coupled to the container via the ring structure. One type of exemplary dispenser is a nipple.

An exemplary method of dispensing food from a container may comprise one or more of the following steps, and not necessarily in the following order: removing a cover having an upper surface and a lower surface from a container body, wherein the container body comprises a neck and a bottom opposite the neck, where a foot is adjacent to the bottom of the container body; moving the cover while the cover is interconnected to the container body via a link; and coupling the cover to the container body so that the lower surface is coupled to the container body via the foot or so that the upper surface blocks access to the neck.

According to another exemplary method of dispensing food from a container may comprise one or more of the following steps, and not necessarily in the following order: removing a cover having an upper surface and a lower surface from a container body, wherein the container body comprises a neck and a bottom opposite the neck, where a foot is adjacent to the bottom of the container body; moving the cover while the cover is interconnected to the container body via a link; and coupling the cover to the container body so that the lower surface is coupled to the container body via the foot or so that the upper surface blocks access to the neck. According to this exemplary method, the step of moving the cover further includes the link interconnecting the cover to the container body via a passage in the container body.

According to another exemplary method of dispensing food from a container may comprise one or more of the following steps, and not necessarily in the following order: removing a cover having an upper surface and a lower surface from a container body, wherein the container body comprises a neck and a bottom opposite the neck, where a foot is adjacent to the bottom of the container body; moving the cover while the cover is interconnected to the container body via a link; and coupling the cover to the container body so that the lower surface is coupled to the container body via the foot or so that the upper surface blocks access to the neck. According to this exemplary method, the step of coupling the cover to the container body includes interconnecting the cover to the container body via a ring structure coupled to the neck of the container body.

According to another exemplary method of dispensing food from a container may comprise one or more of the following steps, and not necessarily in the following order: removing a cover having an upper surface and a lower surface from a container body, wherein the container body comprises a neck and a bottom opposite the neck, where a foot is adjacent to the bottom of the container body; moving the cover while the cover is interconnected to the container body via a link; and coupling the cover to the container body so that the lower surface is coupled to the container body via the foot or so that the upper surface blocks access to the neck. According to this exemplary method, the step of moving the cover includes rotating the cover so that the upper surface goes from above the neck of the container body to below the bottom of the container body.

According to another exemplary method of dispensing food from a container may comprise one or more of the following steps, and not necessarily in the following order: removing a cover having an upper surface and a lower surface from a container body, wherein the container body comprises a neck and a bottom opposite the neck, where a foot is adjacent to the bottom of the container body; moving the cover while the cover is interconnected to the container body via a link; and coupling the cover to the container body so that the lower surface is coupled to the container body via the foot or so that the upper surface blocks access to the neck. According to this exemplary method, the step of moving the cover includes rotating the cover so that the upper surface goes from below the bottom of the container body to above the neck of the container body.

An exemplary food-containment device may comprise a container having a hollow body with an open neck and closed bottom, a cover having a hollow body with an open mouth and a closed top, the mouth of the cover being secured to the container at a position substantially at the closed bottom of the container such that the closed top faces the closed bottom; and a tether interconnecting the container to the cover.

Another exemplary food-containment device may comprise a container having a hollow body with an open neck and closed bottom, a cover having a hollow body with an open mouth and a closed top, the mouth of the cover being secured to the container at a position substantially at the closed bottom of the container such that the closed top faces the closed bottom; and a tether interconnecting the container to the cover. According to this exemplary food-containment device, the device may also have a ring coupled to the open neck of the container.

Another exemplary food-containment device may comprise a container having a hollow body with an open neck and closed bottom, a cover having a hollow body with an open mouth and a closed top, the mouth of the cover being secured to the container at a position substantially at the closed bottom of the container such that the closed top faces the closed bottom; and a tether interconnecting the container to the cover. According to this exemplary food-containment device, the mouth of the cover is configured to secure the cover to either of the ring and the closed bottom.

Another exemplary food-containment device may comprise a container having a hollow body with an open neck and closed bottom, a cover having a hollow body with an open mouth and a closed top, the mouth of the cover being secured to the container at a position substantially at the closed bottom of the container such that the closed top faces the closed bottom; and a tether interconnecting the container to the cover. According to this exemplary food-containment device, the device may also have a dispenser interconnected to the open neck of the container.

### BRIEF DESCRIPTION OF THE DRAWINGS

FIGS. 1-2 illustrate an exemplary food-holding device according to a first embodiment in which the cover is on and then removed from the food-holding device.

FIG. 3 illustrates a profile view of an exemplary food-holding device according to a first embodiment.

FIGS. 3A and 3B illustrate profile views of an exemplary food holding device and cover as may be illustrated when viewing the portion identified by “A-A” in FIG. 3.

FIG. 4 illustrates another exemplary food-holding device according to a second embodiment.

FIG. 4A illustrates an exemplary profile and sectional view of the food-holding device according to a second embodiment.

FIG. 4B illustrates a further sectioned view of the exemplary profile and sectional view of the food-holding device according to a second embodiment identified by “B-B” in FIG. 4A.

FIGS. 5A-C illustrate an exemplary food-holding device in isometric and profile sectional views according to a third embodiment.

FIG. 6A illustrates a prior art food-holding device in isometric view.

FIGS. 6B-D illustrate an exemplary food-holding device in cross-sectional views according to a fourth embodiment.

In the drawings like characters of reference indicate corresponding parts in the different figures. The drawing figures, elements and other depictions should be understood as being interchangeable and may be combined in any like manner in accordance with the disclosures and objectives recited herein.

### DETAILED DESCRIPTION

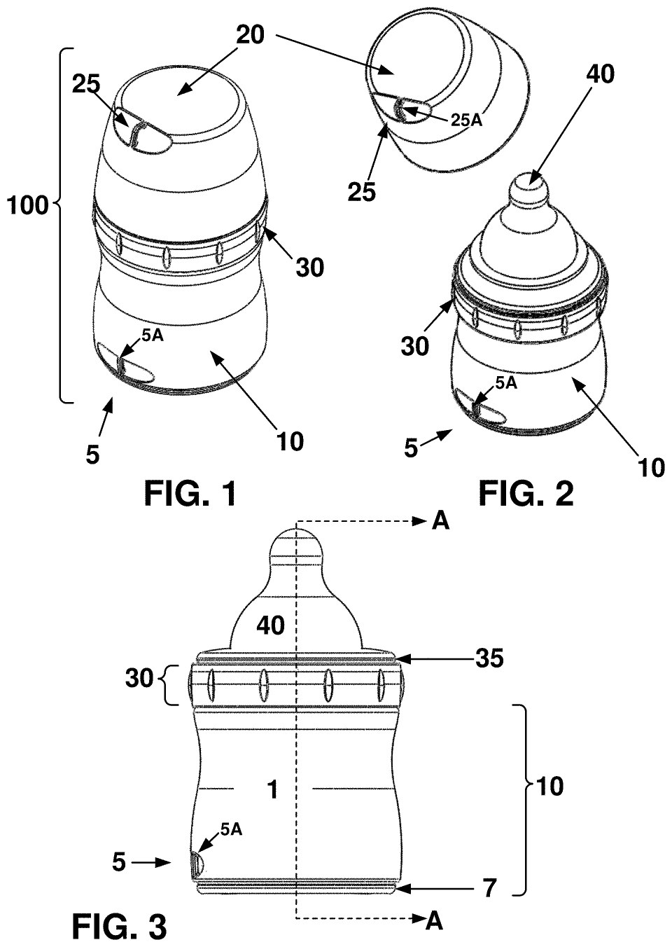

Referring to FIGS. 1-3 and 3A-B, an exemplary food holding device 100 may be illustrated in the form of a baby bottle. However, those with ordinary skill in the art would understand device 100 may be any type of apparatus for holding food, including, thermos, canteen, adult beverage bottles, jugs, rectangular food packaging, and other means of holding and storing food known to those skilled in the art. As depicted in FIGS. 1-3, an exemplary device 100 may comprise a container portion 10, a cover 20, container ring 30, and a dispenser 40, which in the case of babies or infants may be a nipple or sippy-nozzle.

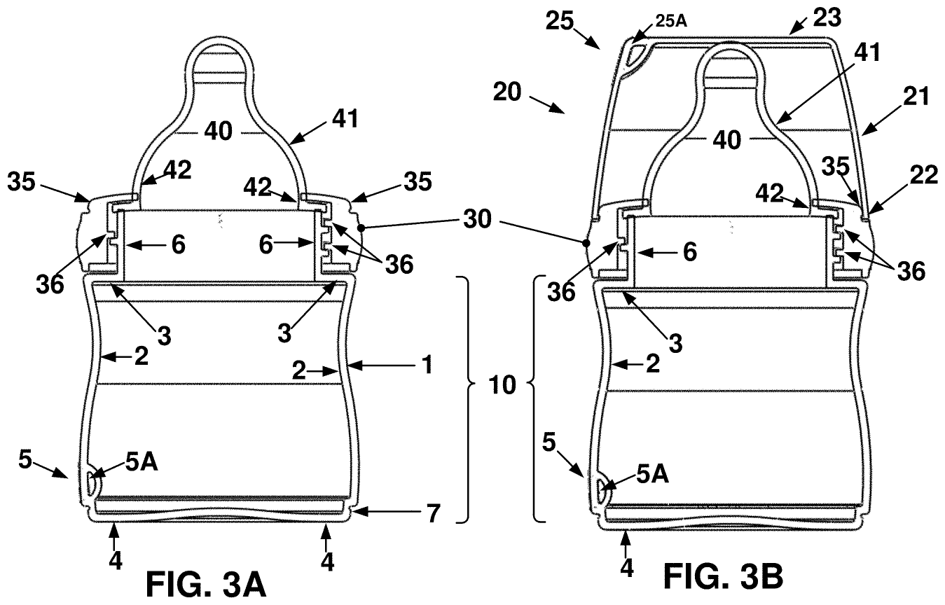

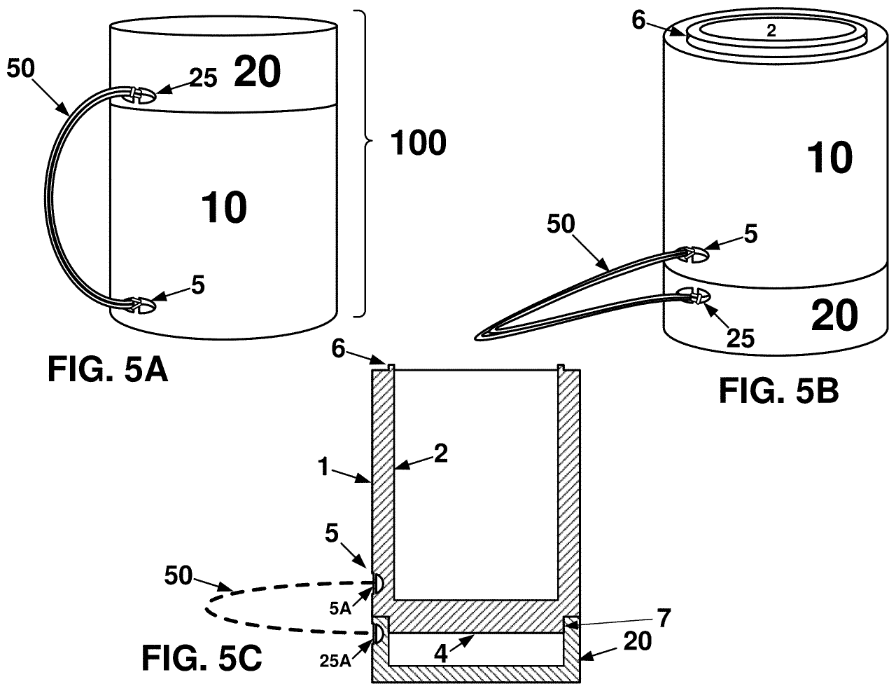

In an exemplary embodiment as depicted in FIGS. 3A-B, an exemplary container 10 may comprise a body 1 having an internal surface 2 and a shoulder 3 from which a neck 6 extends. Further, an exemplary container 10 may comprise a foot 7 that may take the form of a surface feature in body 1 that may be set axially inwardly from the outermost extent of body 1. Alternatively, foot 7 may be any surface or contour that may be used to secure a structure thereto. Along the body 1 may be found at least one passage 5 through which a lanyard, string, strap, or belt may be passed and/or inserted and/or coupled to the body 1 via arm 5A. For example, the lanyard, string, or strap may be clipped or plugged into passage 5 using friction of arm 5A to stay inserted therein. As shown in FIGS. 3A-B, an exemplary shoulder 3 may be disposed further axially-inwardly than foot 7 to allow for the extension of neck 6 therefrom. Alternatively, an exemplary shoulder 3 may not be needed depending on the style of neck 6 used for a particular container 10, as may be illustrated in FIGS. 5A-C. An exemplary neck 6 may have threading to interconnect with corresponding threads 36 of an exemplary container ring 30. According to one embodiment, container ring 30 may affix a spout, dispenser, or nipple 40 to the container 10 using a locking ledge 35 that frictionally affixes or exerts pressure or mechanically clinches spout flange 42. The remainder of the spout 41 may extend away from container ring 30 to allow for dispensing of the contents in the container 10. Simultaneously, locking ledge 35 may also provide a point of friction or adherence coupling between cover 20 and container ring 30 at the cover interior surface 22. Thus, in an exemplary embodiment, an exemplary cover 20 for a container 10 may be coupled thereto not directly by a neck 6 of container 10, but via the container ring 30. However, container ring 30 may not be necessary for connecting container 10 and cover 20 where neck 6 has been configured for such a configuration, as may be illustrated in FIGS. 5A-C.

Depicted in FIG. 1 is an exemplary passage 5, which may appear as a scalloped region in the lower part of container 10 and a vertically extending post most proximal to the outer surface of portion 10. Like container 10, the cover 20 may also have a scalloped region in passage 25 in the upper part of cover 20. While not shown, a lanyard, string, strap, or belt may be passed and/or inserted and/or coupled between passages 5 and 25 so that the cover 20 may be interconnected to container 10. Referring to FIG. 2, when cover 20 is removed, an exemplary container 10 may also hold a dispenser 40 thereto via container ring 30. In an exemplary embodiment, and with reference to FIG. 3, an exemplary container ring 30 may be any structure that can be secured to container 10 via mechanical attachment (friction fit, snap-fit, screw threads) or may be affixed thereto using screws, sonic welding, or any other known form of mechanical or chemical affixation.

In the exemplary embodiment of FIG. 3, the cover 20 may hold to container 10 via the locking surface 35 found on the ring structure 30. However, an exemplary container 10 may also have a body 1 with a thickness in which passage 5 is found and a foot 7 located in a distal position opposite the surface nearest to ring 30. In this exemplary embodiment, the coupling features of surface 35 may be replicated on foot 7 to permit container 10 to couple cover 20 thereto when the cover 20 is not otherwise coupled to locking surface 35, i.e., both surface 35 and foot 7 may have compatible surface cross-sections for retaining the interior surface 22 of cover 20. Thus, it is one aspect of this exemplary embodiment that cover 20 be configured to secure to container body 1 via either neck 6 and/or ring structure 30 while also be configured to secure to foot 7 located at the bottom 4 of the container body 1.

As may be further illustrated by FIGS. 1-3 and 3A-B, arms 5A and 25A in passages 5 and 25, respectively, may be included in and/or integrally molded to body 1 of container 10 and/or wall 21 of cover 20, respectively. In a preferred embodiment, arm 25A may be configured so that it has at least one part lying in the same plane as the top surface 23 of cover 20. According to this preferred embodiment, arm 25A may provide contact with any surface on which it and the upper surface 23 of cover 22 may come into contact. In another preferred embodiment, arm 25A may be disposed at a distance from the top surface 23 of cover 20, as may be illustrated in FIGS. 5A-C. While arms 5A and 25A may be depicted as bars, the skilled artisan would understand that arms 5A and/or 25A may be configured in various forms and varieties to affect the disclosures of the food containing device 100 herein.

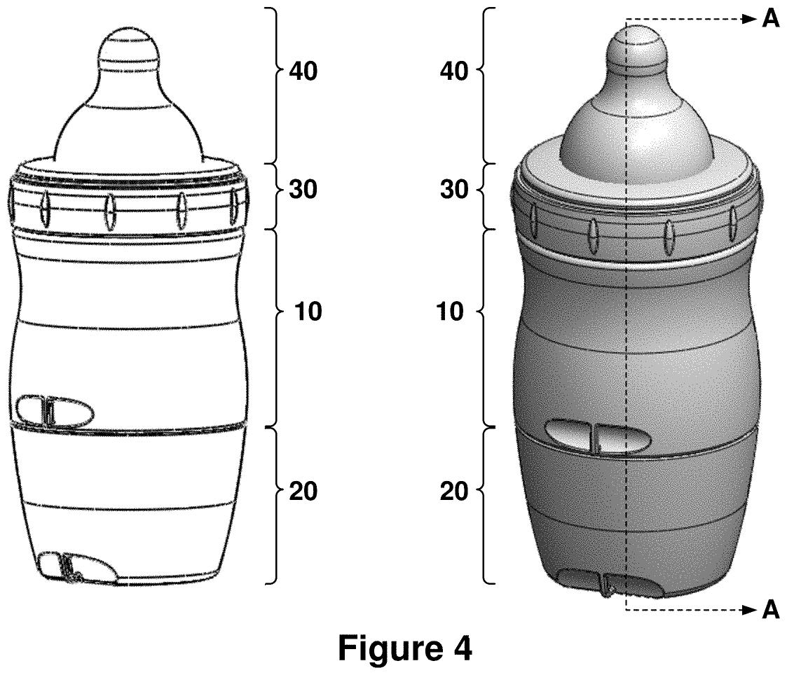

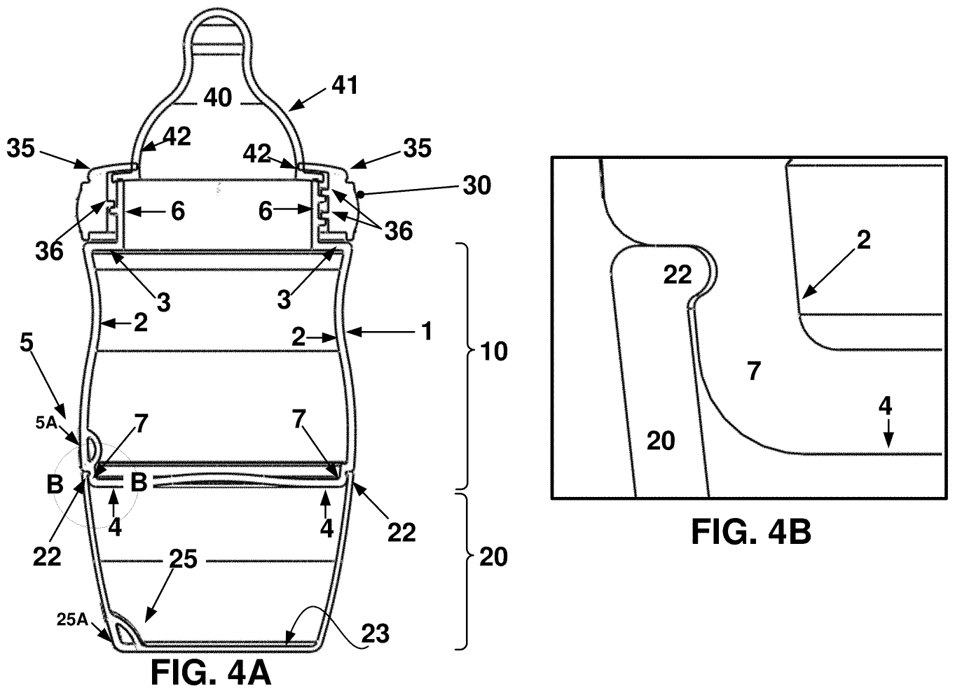

FIG. 4 provides another exemplary embodiment of a food containing device 100 comprised of a dispenser 40 coupled to a container 10 via container ring 30 and a cover 20 disposed on the underside of the container 10. A coupling link (not shown) may be used to interconnect the cover 20 via passage 25 and arm 25A to the container 10 via passage 5 and arm 5A. The section marked “A-A” in FIG. 4 may be illustrated using FIG. 4A. While the arms 25A and 5A may appear aligned in FIG. 4, this configuration is not required for operation of the inventive device 100. A person skilled in the art would understand that with sufficient length of coupling link (not shown), arms 5A and 25A may be located completely opposite one another about an axis of the container device 100 and still permit operation in accordance with the disclosures herein.

FIG. 4A may illustrate a profile cross-section of the embodiment illustrated in FIG. 4. As shown, each of the aforementioned elements described with respect to FIGS. 3A-B are present with the additional feature being the coupling between cover 20 and container 10 at foot 7. As shown, the interior surfaces 22 of cover 20 may have contours that allow it to snuggly fit within a groove formed in foot 7. As such, cover 20 may be just as capable of affixing to container 10 either above (via ring 30 and/or neck 6 and/or shoulder 3) or below (via foot 7 about bottom 4). A more close-up version of this coupling may be had with viewing section “B-B” in FIG. 4A, which may be reproduced in larger perspective in FIG. 4B.

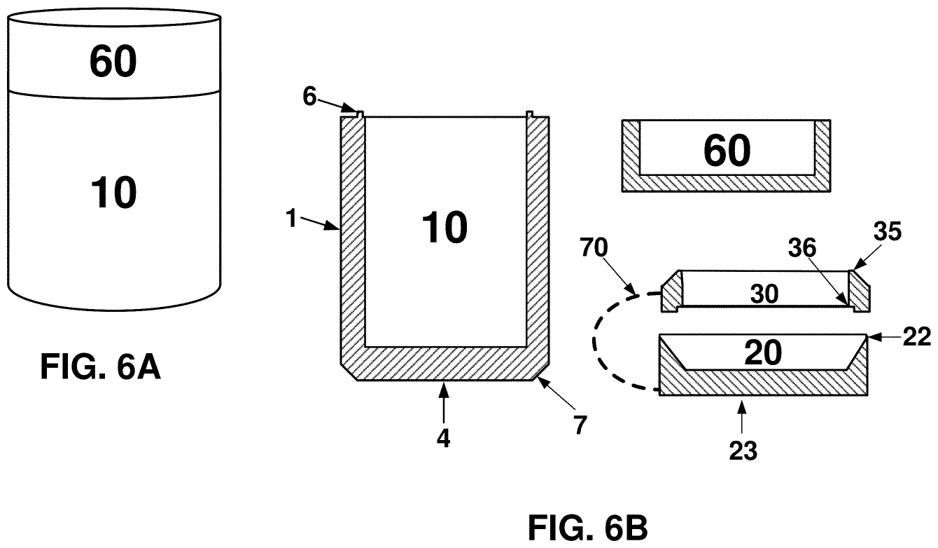

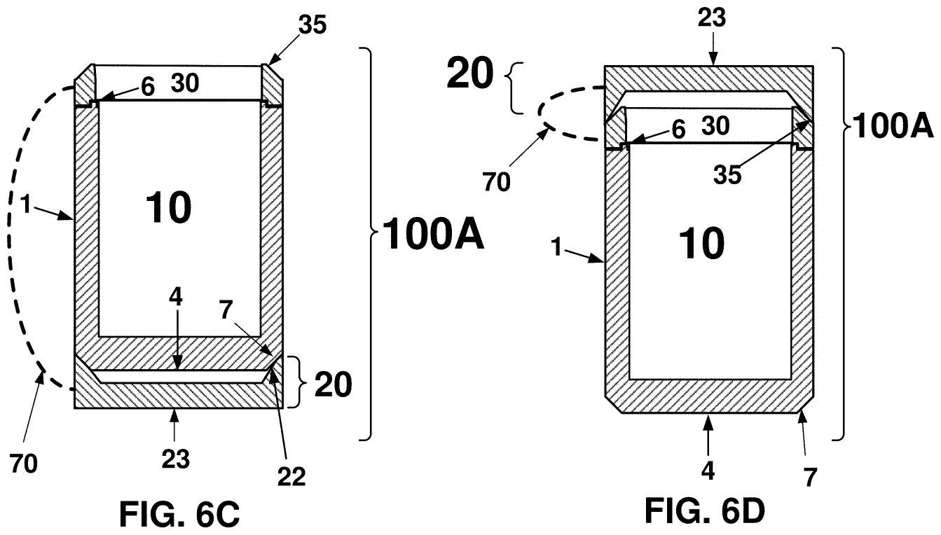

According to the exemplary embodiments of FIGS. 5A-C, an exemplary device 100 may have a cover 20 coupled to a container 10 via a link 50 that is found in passages 5 and 25 of container 10 and cover 20, respectively. When an exemplary cover 20 is removed from an exemplary neck 6 of container 10, exposing interior surface 2 when not filled with an edible material, the cover 20 may be flipped so that the surface once in contact with neck 6 shall now be in contact with foot 7 disposed at the bottom of container 10. As described and illustrated in FIGS. 1-3 and 3A-B, an exemplary container 10 may be configured so that it has at least its bottom 4 surface features, e.g., foot 7, capable for coupling with cover 20 that may otherwise be configured to couple to one or more of shoulder 3, neck 6, and/or ring structure 30. To the extent a particular cover 20 may not couple to a particular bottom 4 of a container 10, a ring structure 30 may be used to adapt a suitably configured cover 20 to couple to a corresponding suitable container 10. Thus, the present invention contemplates numerous forms and types of covers 20 that can be fabricated by those skilled in the art to couple to a ring 30 and also couple to the bottom of a particular container 10 as may be illustrated by FIGS. 6A-D.

As illustratively shown in FIG. 6A, an exemplary container 10 may be manufactured to couple with cover 60 using its neck 6. However, such a container 10 and cover 60 are not in accordance with the teachings herein because such a cover 60 is neither tethered and/or coupled to container 10 other than at neck 6 nor is it capable of coupling to the foot 7 of container 10. Referring to FIG. 6B, an exemplary ring 30 may be configured to have two surfaces: a cover 20 coupling surface 35 and a neck 6 coupling surface 36, whereby a portion of ring 30 may couple via tether or otherwise via link 50 to an exemplary cover 20 that may have a surface 22 configured to couple the foot 7 of the container 10. An exemplary link 70 may be manufactured to be coupled to cover 20 and ring 30 in the same fashion as link 50 or may be formed from a single integral material, such as, for example, rubber, silicone, or another plastic. In a preferred embodiment, the combination of ring 30, link 70, and cover 20 may be injection molded in a single mold. Alternatively, ring 30 and cover 20 may be injection molded about link 70 through insertion injection molding known to those skilled in the art. Thus, an artisan of ordinary skill may use the ring 30 to substitute for off-the-shelf cover 60 of container 10 and transform container 10 into an adapted food container device 100A whereby cover 20 and link 70 may be tethered to container 10 via link 70. In an alternative embodiment, the ring 30 may be molded from an elastomeric material, such as silicone, to allow it to stretch and/or frictionally and snuggly fit around the neck 6 of one or more types of containers 10 as well as one or more types of container bottom 7. According to this alternative embodiment, the link 70 may be separately looped through similar structures as in injection molded versions of ring 30 and/or be over-molded using over-molding rubber injection technologies known to those skilled in the art.

Upon substitution, FIGS. 6C-D may illustrate the permutations of assembly of an exemplary food container device 100A whereby the new cover 20 may be tethered to container 10 via the link 70 to ring 30 so that it may couple to the foot 7 of container 10 as well as to the complementary surface 35. In embodiments where link 70 may not be integral or molded together with ring 30 and/or cover 20, the manufacture of an exemplary adapted food container device 100A may only require manufacture of suitable rings 30 and covers 20 according to the teachings above with the addition of compatible links 70, such as, for example, clasp connectors, lanyards, straps, and other elongate tethers known to those skilled in the art.

In an embodiment, all parts of devices 100 and/or 100A, including container 10, cover 20, ring 30, dispenser 40, coupling link 50, and coupling link 70, may be machine-washable, food-safe, sufficiently heat resistant to be sterilized, and be durable to withstand repeated use. Additionally, each of devices 100 and 100A may be safe for use with infants and children. In the event coupling link 50 may need to be replaced, in embodiments where coupling within passages 5 and/or 25 are not permanent, links 50 and/or 70 may be repaired and/or replaced. Further, each of the above components of devices 100 and 100A may be injection molded, blow molded, thermoformed, additive manufactured, and/or otherwise made according to any known molding techniques in the art.

Many further variations and modifications may suggest themselves to those skilled in art upon making reference to above disclosure and foregoing interrelated and interchangeable illustrative embodiments, which are given by way of example only, and are not intended to limit the scope and spirit of the interrelated embodiments of the invention described herein.

1. A food-containing device, comprising:
a substantially rigid container having a body, the body having a foot and a neck, wherein the neck defines an opening in the body and the foot is adjacent a bottom of the body;
a cover having an upper surface and a lower surface, the upper surface being configured to block the opening in the neck when interconnected thereto and the lower surface being configured to couple the cover to the foot of the body such that the upper surface is in a plane substantially parallel to the bottom of the body; and
a flexible link for interconnecting the cover to the container.

2. The food-containing device of claim 1, wherein the upper surface of the cover is interconnected to the neck via a ring structure coupled to the neck.

3. The food-containing device of claim 2, further comprising a dispenser coupled to the container via the ring structure.

4. The food-containing device of claim 3, wherein the dispenser is a nipple.

5. The food-containing device of claim 4, wherein the container is safe for use with infants.

6. The food-containing device of claim 1, wherein the upper surface of the cover is interconnected to the neck via one or more surfaces on the neck.

7. The food-containing device of claim 1, wherein one end of the flexible link is coupled to the cover via a passage in the cover and another end of the flexible link is coupled to the container via a passage in the container.

8. The food-containing device of claim 7, wherein the upper surface of the cover is interconnected to the neck via one or more surfaces on the neck.

9. The food-containing device of claim 8, further comprising a dispenser coupled to the container via a ring structure.

10. The food-containing device of claim 9, wherein the dispenser is a nipple.

11. The food-containing device of claim 10, wherein the container is safe for use with infants.

12. A method of dispensing food from a container, comprising the steps of:
removing a cover having an upper surface and a lower surface from a container body, wherein the container body comprises a neck and a bottom opposite the neck, where a foot is adjacent to the bottom of the container body;
moving the cover while the cover is interconnected to the container body via a link; and
coupling the cover to the container body so that the lower surface is coupled to the container body via the foot or so that the upper surface blocks access to the neck.

13. The method of claim 12, wherein the step of moving the cover further includes the link interconnecting the cover to the container body via a passage in the container body.

14. The method of claim 12, wherein the step of coupling the cover to the container body includes interconnecting the cover to the container body via a ring structure coupled to the neck of the container body.

15. The method of claim 12, wherein of moving the cover includes rotating the cover so that the upper surface goes from above the neck of the container body to below the bottom of the container body.

16. The method of claim 12, wherein of moving the cover includes rotating the cover so that the upper surface goes from below the bottom of the container body to above the neck of the container body.

17. A food-containment device, comprising:
a container having a hollow body with an open neck and closed bottom;
a cover having a hollow body with an open mouth and a closed top, the mouth of the cover being secured to the container at a position substantially at the closed bottom of the container such that the closed top faces the closed bottom; and
a tether interconnecting the container to the cover.

18. The food-containment device of claim 17, further comprising a ring coupled to the open neck of the container.

19. The food-containment device of claim 18, wherein the mouth of the cover is configured to secure the cover to either of the ring and the closed bottom.

20. The food-containment device of claim 19, further comprising a dispenser interconnected to the open neck of the container.
